(19) United States
(12) Patent Application Publication
(10) Pub. No.: US 2011/0214806 A1
(43) Pub. Date: Sep. 8, 2011

(54) INGOT FORMED FROM BASIC INGOTS, WAFER MADE FROM SAID INGOT AND ASSOCIATED METHOD

(76) Inventor: Bruno Ghyselen, Swyssinet (FR)

(21) Appl. No.: 13/128,609

(22) PCT Filed: Nov. 26, 2009
(86) PCT No.: PCT/EP2009/065905

§ 371 Date: May 10, 2011

(30) Foreign Application Priority Data
Dec. 1, 2008 (FR) 08 58159

(51) Int. Cl. B32B 37/14; B32B 37/02; B32B 37/06; B32B 37/10; B32B 38/10; B32B 37/12

(52) U.S. Cl. 156/247

(57) ABSTRACT

A method for manufacturing a heterostructure for use in applications in the electronics, optical and optoelectronics fields, by implanting atomic species inside a first substrate called “donor” substrate, so as to form an embrittlement area therein, assembling a second substrate, called “recipient” substrate, on the donor substrate, detaching the rear portion of the donor substrate along the embrittlement area, so as to customize a thin layer of interest on the recipient substrate, wherein the donor substrate is an ingot or an ingot section formed from at least two basic ingots assembled together along two of their respective complementary longitudinal surfaces.

The present invention relates to a method for manufacturing a heterostructure, in particular for use in applications in the electronics, optical, optoelectronics, and photovoltaic fields.

In general, electronic components are formed on semiconductor wafers that are generally circular, about 100 to 300 millimeters in diameter. Each wafer may thus comprise numerous components. Historically, improvements in performance, and reductions in manufacturing costs of the electronic devices have been achieved mainly by a higher component integration density and by increasing the size of the wafers which accommodate them.

The size of the ingots and the wafers made from them is directly related to the type of material of their composition. Thus, for example, the latest generations of monocrystalline silicon wafers for microelectronics applications are available in the form of circular wafers having a diameter of 300 mm. Germanium wafers are available in the form of circular wafers having a diameter of 200 mm. Similarly, SiC and GaN wafers have a diameter of 100 mm.

The preparation of ingots and wafers having an unconventional size and/or dimension and/or shape, that is to say different from that (those) commonly employed, demands a high investment in development.

Techniques are known for producing substrates assembling layers together on a larger support. Thus, document US 2007/0026638 proposes a technique for making substrates, obtained by transfer of a large number of layers issuing from donor substrates on such a support.

The technique described in this document nevertheless requires the transfer of many layers, which represents a large number of steps and is therefore uneconomical, for making the final large substrate.

Moreover, this document does not solve the problem of supplying the support which has an unconventional size, that is to say unusual for the material and the intended application, with regard to current practices.

This problem of supplying ingots and wafers having unconventional dimensions is nevertheless described and solved in particular in documents JP-02-219606, EP-0 367 536, JP-2008-087980, EP-0 416 301 and DE-19 549 513.

The wafers described in these documents are made from ingots or ingot sections assembled together.

However, the wafers thus obtained remain brittle at the connections of their component subassemblies.

It is the object of the present invention to solve this problem by proposing a method for manufacturing an assembly that does not have the property of brittleness.

Thus, the present invention relates to a method for manufacturing a heterostructure, in particular for use in applications in the electronics, optical and optoelectronics fields, said method comprising the following steps:
implanting atomic species inside a first substrate called “donor” substrate, so as to form an embrittlement area therein,
assembling a second substrate, called “recipient” substrate, on the donor substrate,
detaching the rear portion of said donor substrate along the embrittlement area, so as to customize a thin layer of interest on the recipient substrate,
characterized in that an ingot or an ingot section formed from at least two basic ingots assembled together along two of their respective complementary longitudinal surfaces, is used as the donor substrate.

In this way, the thin layer of interest is formed from a “slice” of an ingot or of an ingot section made from at least two basic ingots, which is supported by said second substrate.

The latter has a stiffener substrate function, which serves to solve the problem of brittleness of the “slice”.

According to other advantageous features:
at least one of the basic ingots is made of a monocrystalline or polycrystalline material;
at least one of the basic ingots is a solid selected from cylinders, prisms, polyhedra, such as a parallelepiped, having a square, rectangular, triangular, pentagonal, hexagonal, heptagonal, octagonal, nonagonal, decagonal cross section, or a cross section in the shape of a circular segment;
the materials of the basic ingots are selected from silicon, germanium, silicon carbide, gallium nitride, gallium arsenide, sapphire, glass, quartz, AIN, InP, ferroelectric materials such as LiTaO₃, LiNbO₃;
a silicon substrate is used as the recipient substrate.

Throughout the present application, the expression “basic ingot” means both a rough ingot and an ingot whose shape has been ground, in particular to remove its outer gangue. A section of such an ingot is also included in this definition.

Furthermore, the expression “longitudinal surfaces” means the surfaces of an ingot whose longest edges are parallel to the longitudinal axis of the initial ingot.

Other features and advantages of the invention will appear from the description that follows, with reference to the appended drawings.

In these drawings:

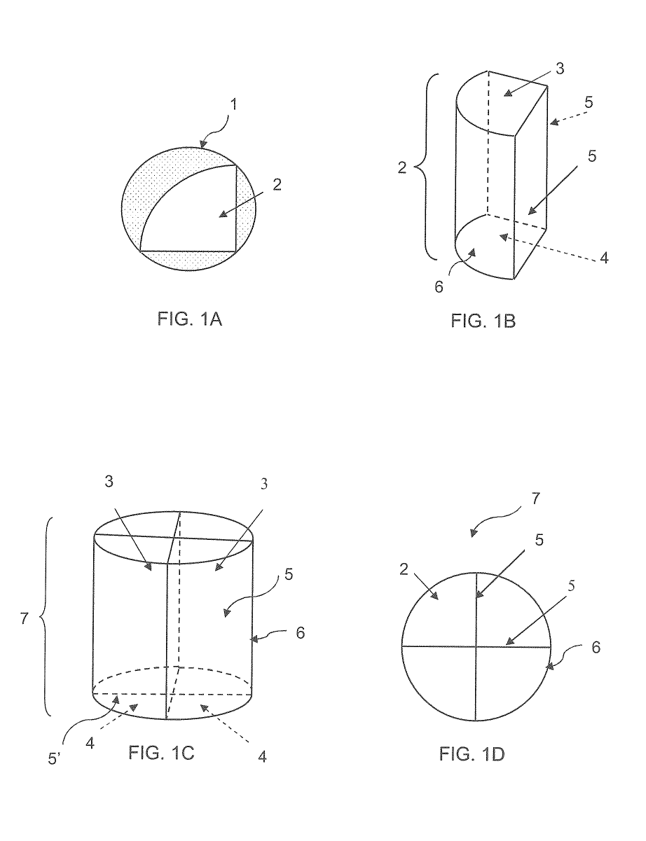

FIGS. 1A to 1D are diagrams showing a first type of ingot usable in the context of the inventive method,

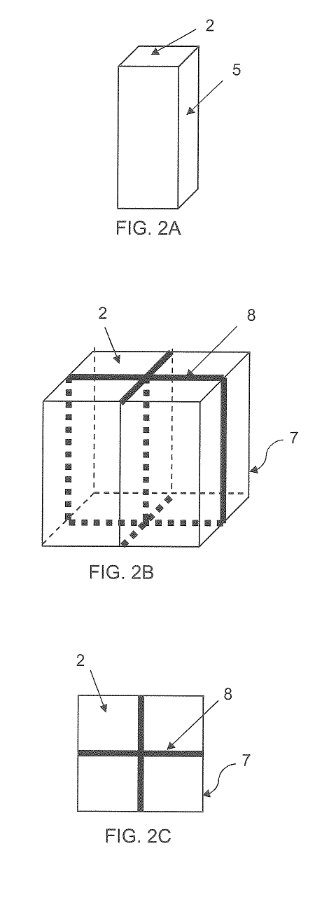

FIGS. 2A to 2C are diagrams showing a second type of ingot usable in the context of the inventive method,

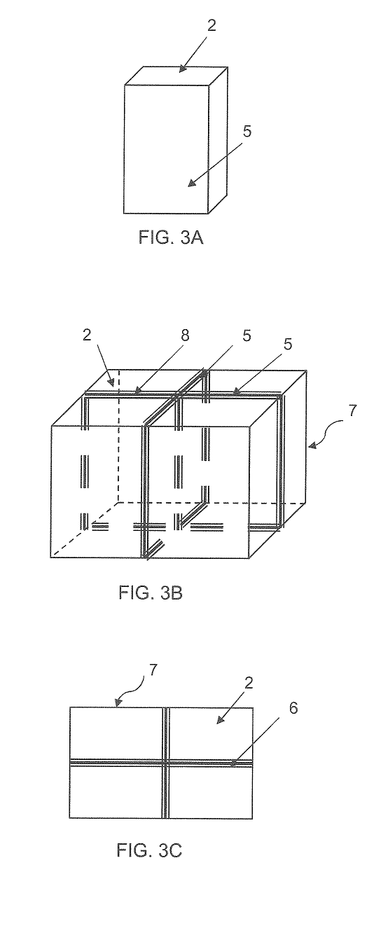

FIGS. 3A to 3C are diagrams showing a third type of ingot usable in the context of the inventive method,

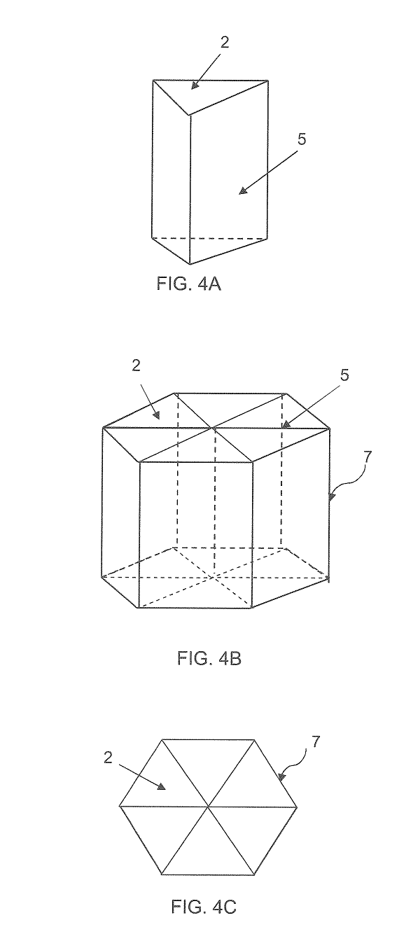

FIGS. 4A to 4D are diagrams showing a fourth type of ingot usable in the context of the inventive method,

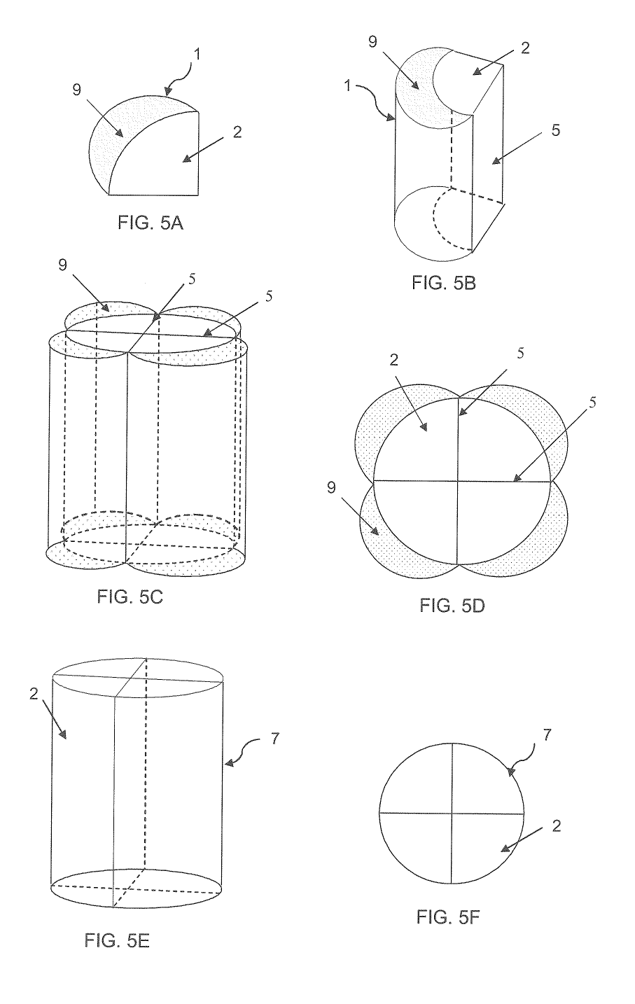

FIGS. 5A to 5E are diagrams showing a fifth type of ingot usable in the context of the inventive method.

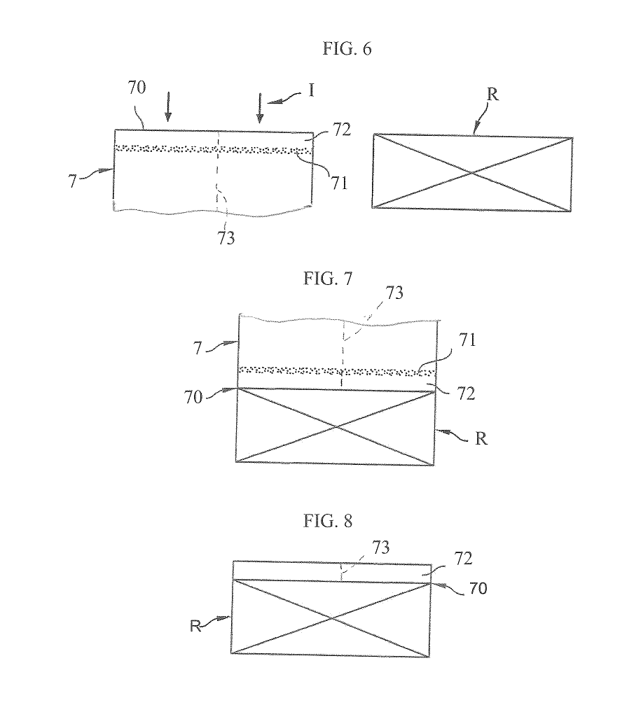

FIGS. 6 to 8 are diagrams showing the essential steps of the inventive method.

In general, the size or diameter of the ingot depends on the type of material of the composition of said ingot. Thus, in the case of monocrystalline silicon, a person skilled in the art today defines a “large diameter” as a diameter higher than 300 mm, more particularly 450 mm, which is described as being the next generation. In the case of monocrystalline germanium ingots, a “large diameter” is defined as a diameter higher than 150 mm, more particularly higher than 200 mm. For polycrystalline ingots, the dimensions qualified as “large diameter” may differ because of the difference in difficulties of obtaining said ingots. For polycrystalline silicon, a “large diameter” is a diameter higher than 500 mm.

The final ingots may have any shape. The shape may, for example, be a polyhedron, whose longest edges are parallel to the main longitudinal axis of the initial ingot. For photovoltaic applications, for example, square wafer shapes are preferred today.

In the case of a polyhedron, the cross section referred to throughout the present description but in a nonlimiting manner, corresponds to the polygon obtained in the plane perpendicular to the longest edges, that is in the plane perpendicular to the longitudinal axis of the ingot. Thus, the final or initial ingots may be selected from polyhedra having a polygonal cross section, the order of the polygon being between 3 (referred to as a triangular section) and infinity, more precisely between 3 and 10 000 (referred to as a myriagonal section). For example, the cross section may also be square, rectangular, pentagonal, hexagonal, heptagonal, octagonal, nonagonal, decagonal. However, it should be noted that there is a tendency to select a high order polygonal cross section in order to limit the loss in the cutting of the polyhedron, if it is obtained from a cylindrical initial ingot.

Furthermore, the cross section of the ingots, in particular of the ingots to be assembled, may also have a circular segment shape, such as for example, a semicircle, or a quarter of a circle, or 1/X of a circle (X between 1 and 100). Polyhedra with a cross section of 1/X of a circle are selected so as to have a suitable radius of curvature according to the diameter of the intended final ingot.

The number of ingots to be assembled depends on the target final shape and also on the initial shape of the ingots to be assembled. Thus, the final large ingot will be made from an assembly of at least two ingots. The ingots to be assembled are made from crystalline or noncrystalline materials.

A first type of ingot usable in the context of the inventive method will now be described briefly.

In a first step, and as shown in FIG. 1A, ingots to be assembled 2 are cut out of a cylindrical initial ingot 1. In this example, the ingots to be assembled 2 have a ¼ circle shaped cross section as shown in FIG. 1B. Each ingot is therefore bounded by two parallel end surfaces 3 and 4 with a quarter circle shaped contour, two large longitudinal surfaces perpendicular to one another 5, and a curved surface (arc of circle) 6. However, more generally, the arc of circle shaped surface may have a suitable radius of curvature according to the diameter of the intended final ingot, but also according to the number of ingots to be assembled, which will be cut out.

The cutting out of the initial ingot 1 serves to obtain the ingot to be assembled 2, and the assembly of four ingots to be assembled 2 serves to obtain a large final ingot 7, that is, having a diameter higher than the diameter of the initial ingot 1 as shown in FIGS. 1C and 1D.

The initial ingots 1 and hence the final ingots 7 are made from crystalline or noncrystalline materials. They are selected from semiconductor materials such as silicon, germanium, silicon carbide, gallium nitride, gallium arsenide and, more generally, compound semiconductors including, inter alia, materials of groups III/V, groups II/VI, or even from sapphire, quartz, piezoelectric, ferroelectric materials, such as LiTaO₃, LiNbO₃.

The assembly of the ingots to be assembled 2 can be carried out by various methods, by all known bonding techniques, for example via a bonding layer (resin, glue, polymer, etc.), by molecular bonding, anodic bonding, or even bonding by fusion of materials (welding, brazing).

In this case, the final ingot 7 in FIGS. 1C and 1D is obtained after the fusion of the interfaces between each of the ingots to be assembled. After preparation of the surfaces 5 of the ingots 2 to be assembled, they are placed in contact and the assembly is then subjected to annealing in which the temperature depends on the material concerned. In the context of the present invention, fusion does not necessarily mean passage into the liquid state, but reconstruction by diffusion across the interfaces of the species in the composition of the material. For silicon, temperatures above 1200° C. are advantageously employed. The preparation of the surfaces 5 of the ingots 2 to be assembled is advantageously one of the shaping steps such as milling, polishing, etc. to make said surfaces sufficiently plane to make them match. This preparation advantageously also comprises cleaning steps (chemical cleaning, brushing, etc.) intended, inter alia, to remove any debris or particle that is too large and liable to penalize the contacting of the surfaces to be bonded. Finally, a press is advantageously used during the fusion heat treatment in order to facilitate the joining and consolidation of the assembly interfaces. Any technique known to a person skilled in the art (in the field of sintered materials for example) can advantageously be employed.

Another embodiment of an ingot will now be described with reference to FIGS. 2A to 2C. The same elements have the same reference numerals and will not be described again.

Here, the ingots to be assembled 2 have the shape of a square section polyhedron as shown in FIG. 2A, the length of the edge of the square is selected according to the size of the target final ingot 7, the surfaces to be assembled being denoted by the numeral 5.

In this particular alternative, a bonding layer 8 is formed on the surfaces 5 of the ingots 2 to be assembled. It should be observed that the bonding layer must be present on all the surfaces or at least on one of the surfaces of the ingots to be assembled 2 which are intended to be contacted with each other. Thus, the number of bonding layers must be adjusted according to the number of surfaces of ingots to be assembled 2 to bond them to one another, but also according to the bonding interface that is to be created, which may comprise one or even two superimposed bonding layers.

In the present case, the bonding layer 8 is a layer composed of the same material but whose crystalline and/or structural properties before bonding are modified with regard to the material to be bonded. In the present case of monocrystalline silicon ingots, the modification consists in using a layer of amorphous, polycrystalline or porous silicon, obtained by any technique known to a person skilled in the art. It may be obtained by deposition, for example by the techniques of Chemical Vapor Deposition (CVD). It may also result from a modification by damage of the surfaces to be bonded. An amorphization following an ion implantation will be advantageous in this respect. The implanted species may either be identical to the material to be assembled, which is silicon here, or different, such as germanium for example. In the latter case, the bonding interfaces may then have a composition deviating from the pure material to be assembled, which is tolerable for most applications. Sandblasting is another example of mechanical damage to modify the silicon surface. The structural modification of the surface to be bonded may also result from an anodization leading to a surface porosification. A plasma treatment may also be employed in the process of modification of the properties of the surfaces to be assembled, such as immersion plasma treatments for example.

The typical thicknesses of the structural modifications range from a few nanometers to a few microns.

In all cases, at least one of the two surfaces of two ingots to be assembled 2 is subjected to the formation of this bonding layer 8. In fact, it may be possible to bond a bonding layer 8 present on the surface 5 of a first ingot to be assembled 2, with the surface 5 of a second ingot to be assembled 2, which is not itself coated with a bonding layer 8. It is also possible for the bonding layer 8 to be present on both surfaces to be assembled.

The contacting of the four ingots to be assembled 2 is shown in FIGS. 2B and 2C.

Surface preparation treatments of the bonding layer 8 may be considered in order to facilitate a good quality bond. The surface of the ingots to be assembled may thus be subjected to cleaning, brushing, drying, surface activation treatments, and also operations aimed to improve the geometry (planarity, roughness, etc.) of the surfaces to be assembled, such as a grinding or polishing step for example.

Once the contact has been made, the structure obtained is subjected to a heat treatment for reconstructing and, generally, recrystallizing the bonding layer 8, at the same time as the surfaces in contact with one another are bonded, in order to obtain the final ingot 7. This heat treatment consists in applying a sufficient temperature which depends on the materials to be assembled and on the type of bonding layers. In the case of silicon ingots and bonding layers made from amorphous silicon, temperatures above 500° C., for a period of 1 minute to 2 hours, are preferred.

A third embodiment, shown in FIGS. 3A to 3C, will now be described. The same elements have the same numerical references and will not be described again.

As in the second embodiment, the material of the ingots to be assembled is preferably silicon, but in this example, photovoltaic applications are particularly intended, and the initial silicon ingots are monocrystalline or polycrystalline. As in the second embodiment, a bonding layer 8 is present at the surfaces to be contacted, but the layers considered are of a different type than that of the material to be assembled. Thus, the object here is to obtain bonding layers by deposition having the property of electrical insulation.

Thus, as shown in FIG. 3A, the ingot to be assembled in the shape of a rectangular cross section parallelepiped, is used as the initial ingot. In this example, four ingots of this type are assembled, but the number of ingots to be assembled is not limited to this figure. It is feasible to assemble two or more than four ingots. In the example described, the ingots to be assembled 2 are made from silicon.

A bonding layer 8 is then formed on the surfaces 5 of the ingot to be assembled 2, which are assembled with the surfaces 5 of other ingots. The bonding layer 8 in the present case corresponds to an insulating layer, such as a layer of silicon dioxide (SiO₂) or even silicon nitride (Si₃N₄), and it may also be made from silicon oxynitride (SiₓO_{y}Nₓ) or any other insulating material, depending on the initial type of ingot treated. In another configuration, in which the ingot to be assembled 2 is made from germanium, it may, for example, be feasible to form a bonding layer 8 of GeOₓN_{y}.

The bonding layer 6 may be formed by one of the various common deposition techniques such as CVD (Chemical Vapor Deposition), PECVD (Plasma Enhanced Chemical Vapor Deposition), LPCVD (Low Pressure Chemical Vapor Deposition).

Alternatively, or in addition to the deposition techniques, the bonding layer may partly be formed by a thermal oxidation culminating in this case in silicon ingots having a surface layer of SiO₂ at the surfaces 5 of the ingots to be assembled 2.

Optionally, the second ingot to be assembled with the first ingot may or may not also be provided with the same bonding layers to culminate in a respectively symmetrical or asymmetrical bonding system.

During this step of the formation of a bonding layer 8, reference marks may also be integrated inside the layer. It may, for example, be feasible to form reference marks which, once the ingots are sliced into wafers, serve to correctly position several wafers upon one another with regard to the existing joints.

The final ingot 7 in FIG. 3C is obtained by molecular bonding. Molecular adhesive bonding, also referred to as direct wafer bonding or fusion bonding, is a technique for obtaining the mutual adhesion of two substrates having perfectly plane (“mirror polish”) surfaces, without the application of an additional adhesive such as a glue.

The bonding is typically initiated by the local application of pressure to the two substrates placed in contact. A bonding wave then propagates over the entire area of the substrates.

To achieve this type of molecular bonding, the ingots to be assembled 2 are subjected at their surfaces 5 to a surface preparation before bonding, which consists initially in a precision mechanical finishing (polishing, grinding) and a cleaning, brushing, drying treatment.

The cleaning may, for example, be an “RCA” clean, to remove the contaminating particles.

For information, treatment with a chemical bath called “RCA” consists in treating said faces in succession with a first solution comprising a mixture of ammonium hydroxide (NH₄OH), hydrogen peroxide (H₂O₂), and deionized water, followed by a second solution comprising a mixture of hydrochloric acid (HCl), hydrogen peroxide (H₂O₂) and deionized water; the application of the various solutions may or may not be combined with brushing.

The ingots are then brushed and/or rinsed (with deionized water for example), and even dried.

Optionally, one or the other or both surfaces 5 to be assembled may be subjected to a plasma activation treatment, under an inert atmosphere, for example containing argon or nitrogen, or under an atmosphere containing oxygen. This activation, if practiced, is preferably carried out after cleaning.

Finally, the four ingots to be assembled are placed in contact with each other, one after the other or simultaneously, in order to obtain a bonding by molecular adhesion, thereby forming the large final ingot 7 as shown in FIG. 3C.

Once the assembly is completed, the final ingot 7 is subjected to a final treatment, such as, for example, a heat treatment for reinforcing the bonding interfaces between the various surfaces 5 of the assembled ingots 2. The heat treatment is applied in a temperature range between 200° C. and 1350° C. in the case of silicon ingots, for a period of 1 minute to 2 hours, or at a temperature above 1500° C. in the case of silicon carbide for the same range of application times. In fact, this final heat treatment is adapted to the types of materials present, aiming at the maximum temperatures corresponding to the melting point of the materials concerned.

A fourth alternative will now be described with reference to FIGS. 4A to 4C.

This embodiment consists in assembling ingots in the form of triangular cross section polyhedra 2, in order to form a final ingot 7 with a hexagonal cross section.

FIG. 4A, for example, describes a first ingot to be assembled 2 made from silicon.

In this embodiment, the ingots to be assembled are bonded to one another by means of silicide layers. Before assembly, at least one of the surfaces to be assembled is directly covered with a silicide layer or with a metal layer whose reaction with silicon at high temperature forms said desired silicide. A heat treatment finally serves to seal the ingots to be assembled definitively, at a temperature which depends on the choice of the silicide, but is generally higher than 350° C. The assembly is advantageously placed under a press during the sealing operation.

This produces a final structure 3 as shown in FIG. 4C.

A fifth alternative will now be described with reference to FIGS. 5A to 5F.

In this alternative, and as shown in FIGS. 5A and 5B, the ingots to be assembled 2 have a quarter circle cross section and are cut from silicon initial ingots 1. The ingot to be assembled can be cut in various ways. Thus, for example, as shown in FIGS. 5A and 5B, only the two surfaces to be assembled 5 are cut out from the initial ingot 1, the remainder 9 being removed after assembly. Another alternative is to cut the ingot to be assembled 2 in a single step from the initial ingot 1 in order to obtain the quarter cylinder ingot in the very first step.

Once the two surfaces 5 of the ingot are cut out, four ingots to be assembled 2 are placed in contact with one another for bonding. The usual preparation steps can be applied on the surfaces 5 of each ingot before bonding.

The assembly of the various ingots to be assembled is obtained by fusion of the opposite matching surfaces, as for the first embodiment of the invention described above.

Once the ingots 2 are assembled, it is then possible to remove the remainder 9 of each initial ingot by various techniques such as, for example, mechanical operations (turning, milling, etc.), in order to obtain the large final ingot 7 as shown in FIGS. 5E and 5F.

The embodiments described previously were focused on silicon, but with a few adjustments within the scope of a person skilled in the art, they also apply to other materials, from which wafers are prepared by cutting out the ingots (crystalline or noncrystalline materials, semiconductor materials such as silicon, germanium, silicon carbide, gallium nitride, gallium arsenide and, more generally, compound semiconductors including, inter alia, materials in groups III/V, groups II/VI, or even sapphire, quartz, AIN, InP, piezoelectric, ferroelectric materials, such as LiTaO₃, LiNbO₃).

Finally, and regardless of the method for manufacturing the final large ingots, said ingots can be cut out in wafers or sections (that is into ingots with smaller dimensions than the final ingot). For example, this therefore produces large wafers, with an area corresponding to the cross section of the final ingot.

However, in such a case, and as already explained above, the wafers may have some mechanical brittleness at the assembly areas.

The inventive method serves to solve this problem of brittleness. Reference can be made to FIGS. 6 to 8 to describe an exemplary embodiment of this method.

A donor substrate 7 of silicon is used (see FIG. 6, left hand portion), consisting of an ingot or an ingot section as described above.

An assembly interface of basic ingots has the reference numeral 73.

A recipient substrate R is also used.

The substrate 7 then undergoes a co-implant of hydrogen and helium ions (arrows I in FIG. 1). This is carried out by using the following doses: H²: between 3 and 6.10¹⁶ at/cm² and He⁺: about 2.10¹⁶ at/cm². The helium is preferably implanted first.

The implanting energies are selected between a few key and 200 kev.

This gives rise to the presence of an embrittlement area 71 which bounds a thin layer 72 having a free upper surface 70. In other embodiments, the embrittlement area may be formed by a simple ion implant, for example of hydrogen ions.

The donor substrate 7 is then transferred to the recipient substrate, as shown in FIG. 7.

Once the bonding is complete, for example by molecular bonding, the assembly thus prepared, as shown in FIG. 7, undergoes a step (annealing, mechanical energy input, etc.) of detaching the thin layer 72, in order to obtain the structure as shown in FIG. 8.

Thus, according to this method, a “film” of GaN made from a wafer, an ingot, or an ingot section made from a GaN substrate obtained by assembling basic ingots of GaN, the substrate having a circular contour and possibly having a diameter of 200 mm, can be transferred to a wafer of solid silicon, known in the prior art (and having a “conventional” size), which itself has a circular contour and a diameter of 200 mm.

It is thereby possible to reinforce the mechanical strength of the “film” made from such a brittle donor substrate, by transferring said film to a mechanically more solid substrate.

1.-5. (canceled)

6. A method for manufacturing a heterostructure for use in applications in the electronics, optical and optoelectronics fields, which method comprises:
implanting atomic species inside a first substrate so as to form an embrittlement area therein,
assembling a second substrate on the first substrate, and
detaching a portion of the first substrate along the embrittlement area so as to transfer a thin layer of interest onto the second substrate,
wherein the first substrate is an ingot or ingot section formed from at least two basic ingots assembled together along two of their respective complementary longitudinal surfaces.

7. The method of claim 6, wherein the first substrate is an ingot formed from at least two basic ingots assembled together along two of their respective complementary longitudinal surfaces.

8. The method of claim 6, wherein the first substrate is an ingot section formed from at least two basic ingots assembled together along two of their respective complementary longitudinal surfaces

9. The method of claim 6, wherein at least one of the basic ingots is made of a monocrystalline or polycrystalline material.

10. The method of claim 6, wherein at least one of the basic ingots is a solid selected from cylinders, prisms, or polyhedra having a square, rectangular, triangular, pentagonal, hexagonal, heptagonal, octagonal, nonagonal, decagonal cross section, or a cross section in the shape of a circular segment.

11. The method of claim 6, wherein a plurality of elongated ingot sections are cut from primary ingots and are then assembled side by side to form the first substrate, with a cross section of the first substrate included a portion of each of the plurality of ingot sections.

12. The method of claim 11, wherein the first substrate is round or square and is made of four ingot sections.

13. The method of claim 11, wherein the first substrate is hexagonal and is made of six ingot sections.

14. The method of claim 11, wherein the ingot sections are assembled by being joined together using a bonding layer, molecular bonding, anodic bonding, or bonding by fusion.

15. The method of claim 11, wherein the first substrate is subjected to a heat treatment prior to assembly with the second substrate.

16. The method of claim 15, wherein the ingot sections are held in a press during application of the heat treatment.

17. The method of claim 6, wherein the materials of the basic ingots are selected from silicon, germanium, silicon carbide, gallium nitride, gallium arsenide, sapphire, glass, quartz, AIN, InP, LiTaO₃, or LiNbO₃.

18. The method of claim 6, wherein the second substrate is a silicon substrate.
